(19) United States
(12) Patent Application Publication
(10) Pub. No.: US 2017/0024087 A1
(43) Pub. Date: Jan. 26, 2017

(54) INTEGRATION OF EMOTIONAL ARTIFACTS INTO TEXTUAL INFORMATION EXCHANGE

(71) Applicants: Shyam PATHY, Bangalore, Karnataka (IN); Pramuk SHYAM PATHY, Bangalore, Karnataka (IN)

(72) Inventors: Shyam PATHY, Bangalore, Karnataka (IN); Pramuk SHYAM PATHY, Bangalore, Karnataka (IN)

(21) Appl. No.: 15/100,260

(22) PCT Filed: Nov. 27, 2014
(86) PCT No.: PCT/IN14/00738

§ 371 Date: May 27, 2016

(30) Foreign Application Priority Data
Nov. 27, 2013 (IN) 5449/CHE/2013

(51) Int. Cl. G06F 3/0482; H04L 29/08; G06F 17/24; G06K 9/00; G06F 3/0484; H04L 12/58; G06T 13/80

(52) U.S. Cl. CPC G06F 3/0482; H04L 51/10; H04L 67/306; G06T 13/80; G06K 9/00302; G06F 3/04847; G06F 17/24

(57) ABSTRACT

The present invention relates to a system of sending a personalized emotional artifact that can be used in-line with text to propagate personal emotional state through textual communication. The emotional artifacts include umoticons and emotional strip. Umoticons are modified self-images, animation of self-images or self-video of a user representing an emotion that can be added along with text communication. Emotional strip is used to finalize text input using multiple “send” buttons. Each button is defined by a colour representing an emotion. The user can send the created textual information with or without the umoticons, encapsulated in the colour of the particular “send” button to the receiver/s

### FIELD OF THE INVENTION

The present invention relates to a system for integrating personalized emotional artifacts into textual communications.

### BACKGROUND OF THE INVENTION

Textual information is propagated as a set of words that makes a sensible sentence. A sentence can be arranged in different ways to propagate the same information. Textual communication is becoming increasingly popular when people want to communicate via machines. Textual information can be propagated to a single receiver or multiple receivers. When a person's machine is exchanging information via textual methods, certain emoticons can be attached to this text to enhance/understand the emotion behind the text.

Nowadays, emoticons play a major role in communication technology. Emoticons are usually a pictorial representation of facial expression. They are small images where people can express their feeling using short combinations of punctuation marks to indicate emotions in a textual communication. Short messaging service, multimedia messaging service and other internet based communication applications facilities/helps to send/receive images from a mobile device.

Various systems have been developed for sending images from mobile devices. For example, United States Patent Application 20130147933 to Kulas, Charles J. et al entitled “User image insertion into a text message” describes a system of inserting image in a text message where the user can capture his/her face so that an emoticon is derived from the image taken and that can be sent to the receiver.

PCT publication 2009056921 to Olsson, Stefan et al. entitled “System and method for facial expression control of a user interface” describes an automated system for facial expression in text message where the user can take a picture of the person (himself/herself) during the time of typing the message. An Emotional Categorization Module is used to choose one for the predetermined emotional categories and selects appropriate emotion to send.

U.S. Pat. No. 8,443,290 to Bill, David S et al. entitled “Mood-based organization and display of instant messenger buddy lists” describes a system where the user can capture his/her present mood using camera to define the actual mood of the user through text message.

U.S. Pat. No. 8,160,549 to Bychkov et al. entitled “Mood-based messaging” describes a portable messaging device where the user can send his/her updated mood via SMS.

However, in the existing art, emotional information may be lost during the exchange of text and most users cannot exhibit a variety of facial expressions when called upon. Majority of the users are only able to recreate a small number of facial expressions. These expressions or emotions are also not displayed physically in many cases. On the receiving end, the human mind has the ability to interpret textual information in many different ways. In this field, the use of Emoticons (small smileys with different emotions) has contributed to add the sender's intended emotional state to the text. However, they are very formal and impersonal. Hence, there is a need for an efficient system for integrating personalized emotional artifacts into textual information.

### SUMMARY OF THE INVENTION

The present invention relates to a system for adding personalized re-usable emotional artifacts to text communication. The user can inculcate their intended emotional state into text communications by using two main libraries of artifacts which are completely independent of each other. The two libraries are (i) Umoticons and (ii) Emotion strip.

According to the invention, the cropped self-images, animation or video of users, also known as Umoticons, are added to text communications. The user can send their own self-image, animation or video, from a set of pre-built libraries, along with or without textual content to convey their emotion. Umoticons provide a personal medium to convey emotion. The content of the Umoticon can be adjusted by the user by re-sizing and panning the umoticon outline and further enhance it by the addition of visual and audible artifacts. Other image characteristics such as brightness, contrast and sharpness can be changed using image controls. The umoticons with different expressions are stored in a library and it can be used later.

The system further includes an emotion strip comprising multiple “send” buttons to propagate the different emotions of the user. Each button is defined by a color representing an emotion. The user can manually choose any buttons based on their requirement. The user can use Umoticons stored in the library and the emotion strip together or just use the Emotion strip.

Therefore, the user can create a complex or simple message, either with or without the aid of the umoticons and the emotion strip and send it to the receiver/s.

### BRIEF DESCRIPTION OF THE DRAWINGS

The objective of the present invention will now be described in more detail with reference to the accompanying drawings.

FIG. 1 illustrates users' self-image and its transition to an Umoticon.

FIG. 2 illustrates picture being taken of a user that is shown in FIG. 1.

FIG. 3 illustrates the edit screen where the users' self-image from FIG. 1 is being edited to convert into an Umoticon shown in FIG. 1.

FIG. 4 illustrates the Umoticon being used in a sentence.

FIG. 5 illustrates the emotion strip having multiple send buttons.

FIG. 6 illustrates the transition of Animated Umoticons.

FIG. 7 illustrates the process of capturing the second image onwards when capturing photos for the animated Umoticons shown in FIG. 6.

FIG. 8 illustrates the edit screen where the users' self-images as shown in FIG. 7 is being edited to convert into an Animated Umoticon shown in FIG. 6.

FIG. 9 illustrates the capturing of a video Umoticon.

FIG. 10 illustrates the edit screen where the users self-video captures as per FIG. 9 is being converted to a video Umoticon.

FIG. 11 illustrates the edit screen where visual artifacts are added to the Umoticon.)

FIG. 12 illustrates the edit screen where audible artifacts are added to the Umoticon.

### REFERENCE NUMERALS

10—Self image
12—Umoticon
14—Imaging device
16—Image view
18—Viewing device
20—Umoticon outline
22—Image Controls
24—Sentence
26—Emotion strip
28—Time Interval between changing of images in an Animated Umoticon
30—Imaging device preview screen
32—Live feed of the imaging device
34—Previously taken image reference in the Animated Umoticon series
36—Active image in the Animated Umoticon series
38—Inactive images in the Animated Umoticon series
40—Record button
42—Video Recording timeline
44—Video Trimming place holders
46—Playback timeline
48—Example Visual Artifact
50—Collection of other artifacts
52—Audio record button
54—Audio recording timeline
56—Audio collection device
58—User

### DETAILED DESCRIPTION OF THE INVENTION

The present invention relates to a system for adding personalized emotional artifacts to text communications. The user can inculcate their intended emotional state into text communications by using two main libraries of artifacts which are completely independent of each other. The two libraries are (i) Umoticons and (ii) Emotion strip. The user can communicate his emotional state to the receiver without having to go through a lot of steps.

According to the invention, the cropped self-images, animation or video of users, also known as umoticons, are added to text communications. The user can send their own self-image, animation or video along with or without textual content to convey their emotion along with the text. Umoticons provide a personal medium to convey emotion than currently existing technologies.

The umoticon is created by the user using the step by step guide provided by the invention. The user can create three kinds of umoticons: static umoticons, animated umoticons and video umoticons. With respect to all three kinds of umoticons the user is given copyrighted references for each umoticon. The user will capture/record a self-image with emotions similar to the reference provided. The user can also capture a self-image using their own reference if required. The provided references can be accompanied by other media such as text, emoticons, audio and video to assist users to replicate the umoticon as close to the reference possible.

The capture of static umoticons are done by using an imaging device or by uploading a previously taken static image. The capture and creation of animation is done by allowing the user to take a set of images with incremental changes or without patented reference images to guide them. Also, as a guide after the first image is taken, the user is provided with the previous image overlaid with reduced transparency on the imaging device's feed with an option to change transparency. In the case of a video umoticon, the user can capture a short video using the imaging device.

Once either of the umoticons are captured, the user can then adjust the image, images for the animation or video by zooming and panning the umoticon outline to fit the required area for the Umoticon. The umoticon outline shape can be customised as per the requirement of the user by either selecting pre-defined shapes or by manually drawing them. The umoticon can be further enhanced by adding pre-defined artifacts such as artwork or sound clips to the umoticon or by manually drawing or recording the artifacts. Other image characteristics such as brightness, contrast, sharpness and image filters can be changed using image controls. The umoticons with different expressions is then stored in a library which can be accessed later. This allows the user to be able to re-use the umoticons as needed and eliminates the need to recreate or remember the emotion of that umoticon every time.

During the use of umoticon, the user will have complete control over which umoticon is sent to the receiver. The library is provided to the user on request when creating the message and the user can manually choose which umoticon they will need to send.

The system further includes an emotion strip which is used to finalize text input using multiple “send” buttons. Like the umoticons, the user will have complete control over the send button used to finalize the text. Each button is defined by a colour representing an emotion and is same across all the devices. When a particular “send” button is chosen, the media that the user/sender would like to propagate is encapsulated in the specific colour. This enables the receiver to identify the emotion that the sender wanted to propagate with the media.

The umoticons combined with the emotion strip help to convey the user's expression along with the text. It helps others/receivers to read and understand the emotion behind the text.

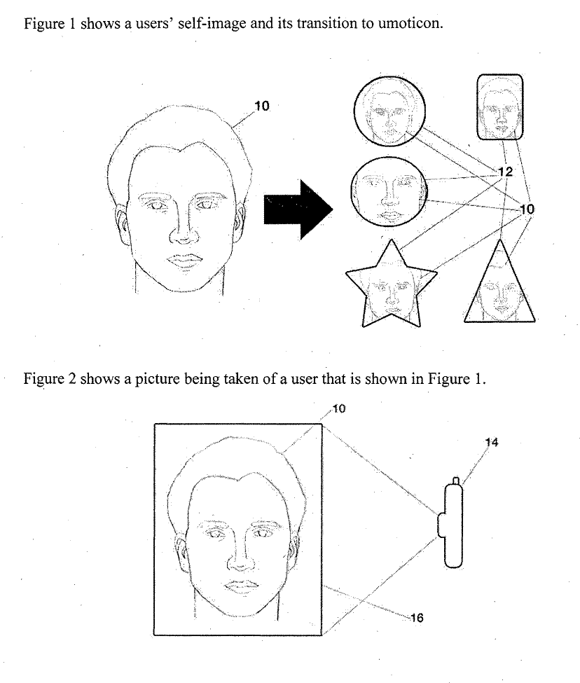

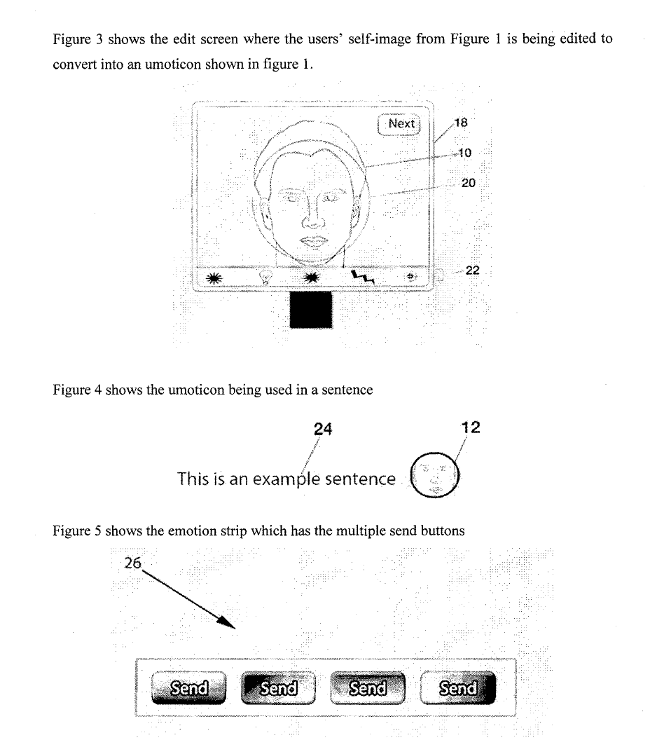

Referring now to the invention in more detail, FIG. 1 shows the users self-image (10) and the umoticon (12). The umoticon (12) is a crop of a users' self-image, circular in this example that can be used in-line with a sentence (24) as shown in FIG. 4 when communicating in a textual medium.)

The Umoticon (12) is created by using the picture of the users' self-image (10). This picture can be taken using an imaging device (14) as shown in FIG. 2 or an existing image can be used. It is important that the picture has the information of the entire image (10) as depicted by the image view (16) in FIG. 2.)

The next step is to edit and refine the image of the users' self-image (10) on a viewing device (18) as illustrated in FIG. 3. The umoticon outline (20) depicts the crop area for the umoticon (12) and the self-image (10) is adjusted by the user by zooming and panning to fit the umoticon outline (20) as favourable to the user.)

Other image characteristics such as brightness, contrast and sharpness can be changed using the image controls (22). Each control provides the user with slider that will help them to change the setting.

The creation of animated umoticons and video umoticons follow a similar process except for the following differences.

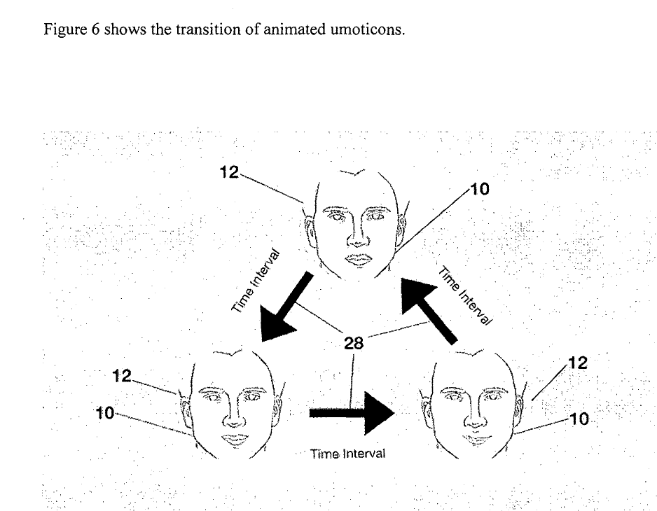

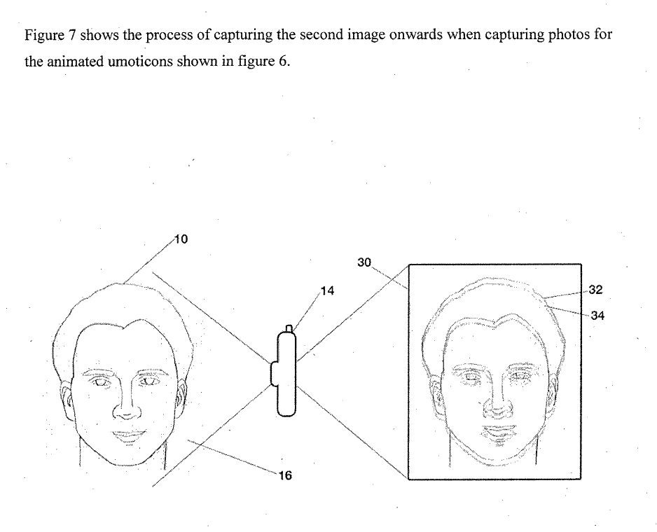

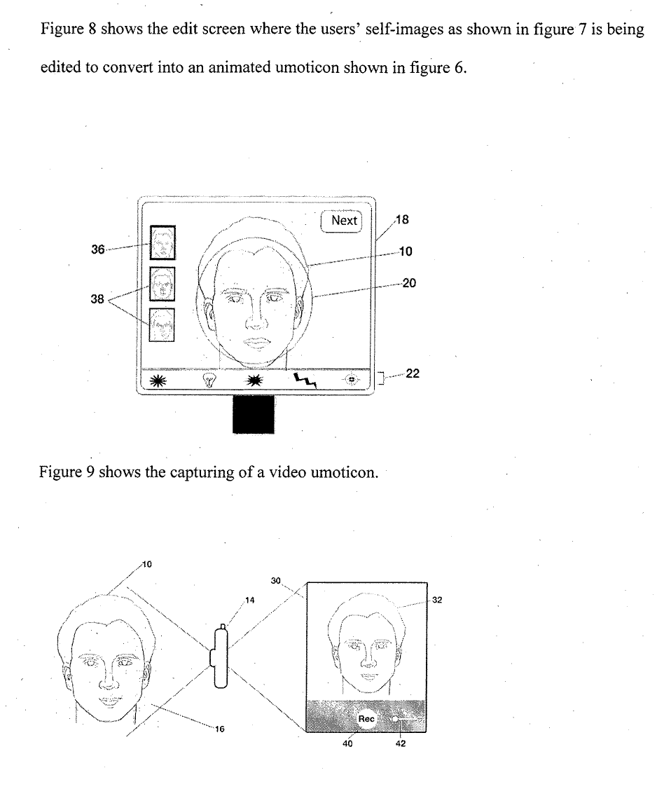

Animated umoticons are a set of 2 or more self-images (10) that are captured using the previously captured image as reference (34) in FIG. 7. These images are displayed one after the other and looped as per FIG. 6. A time interval (28) defines the amount of time to wait until the next image is shown.

The first image for the animated umoticon is taken as per FIG. 2. However from the second picture onwards, the previously captured image (34) is overlaid on the live feed (32) on the preview screen (30) as reference so that user can compare the two images and align the picture.

Once the self-images (10) are captured for the animated umoticon, the next step is to edit the self-images (10) on a viewing device (18) as illustrated in FIG. 8. The screen provides the same functionality as the editing option illustrated in FIG. 3 but further provides the option to choose between the self-Images that were captured as shown in FIG. 7. The user is able to choose a self-image (10) which will make it active (36) for the user to edit. The other inactive images (38) are also shown on the viewing device to allow the user to switch between the images at any time during the edit process. Multiple self-images (10) can be chosen to edit together.

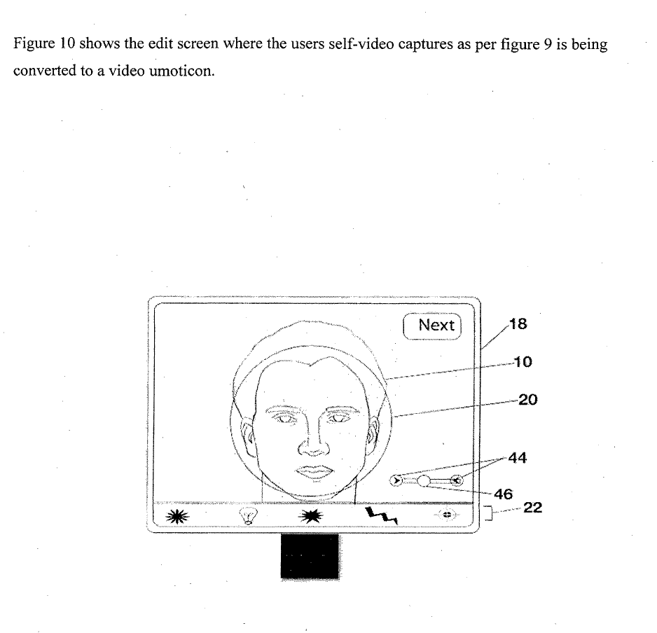

Video umoticon is a short video clip of the user that is cropped using a desired umoticon outline and replayed continuously when used. The capture of a video umoticon is illustrated in FIG. 9 where the user uses the record button (40) to capture a short self-video. The remaining time of the video is shown by video recording timeline (42) on the preview screen (30).

Once the short self-video is captured, the user can edit the video on a viewing device (18) as illustrated in FIG. 10. The edit options illustrated in FIG. 3 are all available here and further have video specific controls. The user can use the playback timeline (46) to scrub to any part of the video for review and also use the video trimming place holders (44) to trim the video.

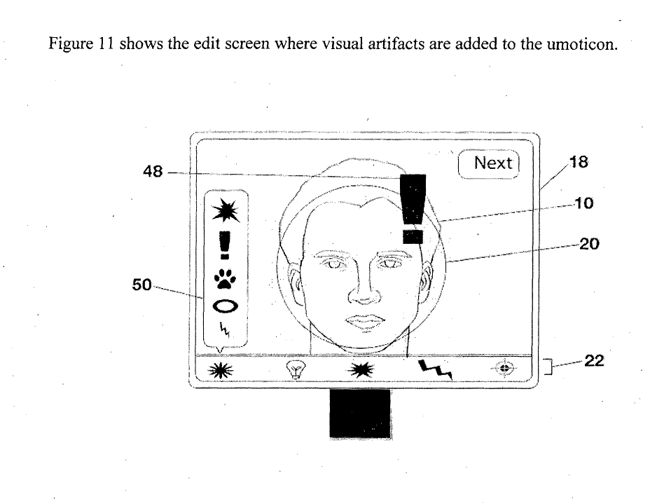

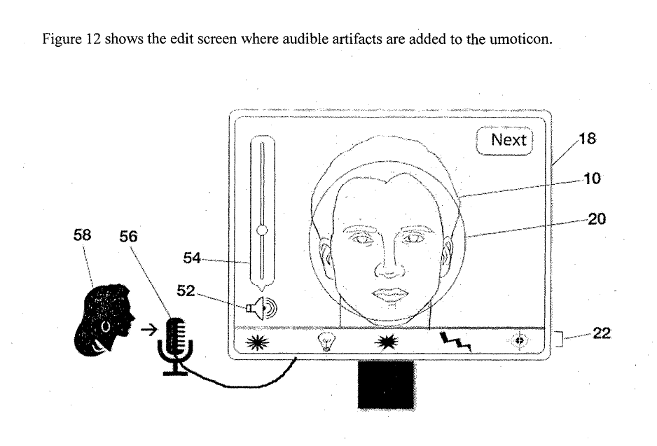

While editing the umoticon the user can add visual (48) and Audible (52) artifacts as shown in FIG. 11 and FIG. 12 respectively. The user is provided options on the viewing device (18) to add these visual (48) and audible (52) artifacts. When choosing to add a visual artifact (48) the user is provided with a set of pre-defined artifacts (50) from which the user can use one or more and place them on the umoticon as per the example (48) depicted in FIG. 11. When choosing to add an audible artifact the user is provided with an audio recording option (52) and the user (58) can record a short audio via an audio collection device (56), the length of which is determined by the audio timeline (54) as in FIG. 12.

Once the user is happy with their umoticon they will save it to their library which will be made available to use in-line when exchanging or posting textual information online. Many umoticons can be created with different facial expressions, animations, videos and artifacts and can be stored in the library.

FIG. 5 shows the emotion strip (26) which comprises of different coloured send buttons, each of which represents a different emotion. These send buttons can be used to propagate the textual information that has been created by the user with or without the use of the umoticons (12) to the receiver/s.

The textual information will be encapsulated in the colour of the send button used, thus propagating the emotion that the sender wanted to display to the receiver/s.

We claim:

1. A system for integrating personalized emotional artifacts into text communications, said artifacts are used to communicate the emotional state of the sender to the receiver without having to go through a lot of steps.

2. The system according to claim 1, wherein said emotional artifacts are stored in two main libraries.

3. The system according to claim 2, wherein said libraries include (i) umoticons and (ii) emotion strip.

4. The system according to claim 3, wherein said libraries are provided to user on request when creating the message.

5. The system according to claim 3, wherein said umoticons are created by using the picture of self-images of user.

6. The system according to claim 3, wherein said emotion strip comprises multiple “send” buttons to propagate textual information created by the user with umoticons.

7. The system according to claim 6, wherein said emotion strip comprises multiple “send” buttons to propagate textual information created by the user without umoticons.

8. The system according to claim 6, wherein said buttons are defined by a color representing an emotion.

9. A method of creating umoticons according to the system comprising: providing copyrighted image references for each emotion; capturing self-image of the user by an imaging device with emotions similar to said references; editing and refining said self-image of said user, on a viewing device; adjusting said self-image by zooming and panning to fit the umoticon outline as favourable to said user; adjusting brightness, contrast and sharpness of said self-image using image controls, said control provides said user with slider to change the setting; storing created umoticons to library; and sending stored umoticons along with the text communication.

10. A system for integrating personalized emotional artifacts into textual communications by the user comprising; inculcating the users emotional state into textual communications by using two main libraries of artifacts which are completely independent of each other, where the two libraries are:
(a) umoticons, and
(b) emotion strip
wherein the user will have complete control over the umoticons and the emotion strip used,
wherein the umoticons either combined with or without the emotion strip help to convey) the user's expression along with the text,
wherein the presence or absence of the umoticon and the text encapsulated with the emotion strip helps others/receivers to read and understand the emotion behind the text.

11. A system for integrating personalized emotional artifacts into textual communications by the user comprising, forming a library of umoticons as claimed in claim 10, where;
(a) the umoticons are cropped self-images, animation or videos of the user that can be used along with or without textual content to convey the users emotion and thereby provide a personal medium to convey emotion,
(b) the umoticons are self-images captured or recorded by the user with emotions similar to the reference provided or using the users own reference, where these references can be accompanied by other media such as text, emoticons, audio and video to assist users to replicate the emoticon as close to the reference possible,
(c) the captured umoticon image, images of the animation or video can be adjusted by the user by zooming and panning the umoticon outline to fit the area required, where the umoticon outline shape can be customised as per the requirement of the user by either selecting pre-defined shapes or by manually drawing them,
(d) the umoticon can be further enhanced by adding pre-defined artifacts such as artwork or sound clips to the umoticon or by manually drawing or recording the artifacts, and
(e) other image characteristics such as brightness, contrast, sharpness and image filters can be changed using image controls,
wherein the umoticons with different expressions is then stored in a library which can be accessed later on request.

12. A system for integrating personalized emotional artifacts into textual communications by the user comprising umoticons as claimed in claim 11, where the umoticons are;
(a) static umoticons done or captured using an imaging device or by uploading a previously taken static image,
(b) animated umoticons done by capturing and creation of animation done by allowing the user to take a set of similar images, and
(c) video umoticons done by capturing a short video using the imaging device.

13. A system for integrating personalized emotional artifacts into textual communications by the user comprising an emotion strip as claimed in claim 10, where the emotion strip is used to;
(a) finalize the text input using multiple “send” buttons, where each button is defined by a colour representing an emotion and is same across all the devices,
(b) choose a particular “send” button, such that the media that the user/sender would like to propagate is encapsulated in the same colour, and
(c) enable the receiver/s to identify the emotion that the sender wanted to propagate with the media.
